(19) United States
(12) Patent Application Publication
(10) Pub. No.: US 2008/0276767 A1
(43) Pub. Date: Nov. 13, 2008

(54) Pliers that Can Operate Workpieces of Two Different Types

(76) Inventor: Chin-Yi Huang, Sihu Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/968,307

(22) Filed: Jan. 2, 2008

(30) Foreign Application Priority Data
May 10, 2007 (TW) 096207515

(51) Int. Cl. B25B 7/16; B25B 7/02

(52) U.S. Cl. 81/319; 81/418

(57) ABSTRACT

A pair of pliers include a fixed handle, a fixed jaw secured to the fixed handle and provided with a first toothed clamping portion and a first holding recess, a movable jaw pivotally mounted on the fixed handle and provided with a second toothed clamping portion and a second holding recess, and a movable handle pivotally mounted on the movable jaw. Thus, the pliers are used to operate a pipe by the second toothed clamping portion and the first toothed clamping portion and to operate a nut or screw by the second holding recess and the first holding recess, so that the pliers can be used to operate workpieces of two different types.

### BACKGROUND OF THE INVENTION

1. Field of the Invention

The present invention relates to a pair of pliers and, more particularly, to a pair of pliers for operating a workpiece, such as a pipe, screw, nut and the like.

2. Description of the Related Art

A pair of conventional pipe pliers are used to operate and rotate a pipe, such as a water pipe and the like, for maintenance or replacement the pipe. However, the pipe pliers cannot be used to operate a workpiece, such as a screw, nut and the like, so that a user has to prepare the pipe pliers to operate the pipe and to prepare a wrench to operate the nut and screw, thereby causing inconvenience to the user when operating the pipe, nut and screw.

### BRIEF SUMMARY OF THE INVENTION

In accordance with the present invention, there is provided a pair of pliers, comprising a fixed handle, a fixed jaw having a first end secured to a first end of the fixed handle, a mediate portion provided with a first toothed clamping portion and a second end provided with a first bent portion which is provided with a first holding recess, a movable jaw having a first end pivotally mounted on the first end of the fixed handle, a mediate portion provided with a second toothed clamping portion facing the first toothed clamping portion of the fixed jaw and a second end provided with a second bent portion which is provided with a second holding recess facing the first holding recess of the fixed jaw, and a movable handle having a first end pivotally mounted on the first end of the movable jaw.

The pliers further comprise a locking lever having a first end pivotally mounted on a mediate portion of the movable handle and a second end adjustably mounted on a second end of the fixed handle, an adjusting screw rotatably and movably mounted on the second end of the fixed handle and abutting the second end of the locking lever to push the second end of the locking lever, and a release lever pivotally mounted on a second end of the movable handle.

The primary objective of the present invention is to provide a pair of pliers that can operate workpieces of two different types.

Another objective of the present invention is to provide a pair of pliers that are used to operate a pipe by the second toothed clamping portion of the movable jaw and the first toothed clamping portion of the fixed jaw and to operate a nut or screw by the second holding recess of the movable jaw and the first holding recess of the fixed jaw, so that the pliers can be used to operate workpieces of two different types, thereby enhancing the versatility of the pliers.

A further objective of the present invention is to provide a pair of pliers, wherein a user only needs to prepare the single pliers to operate workpieces of two different types, thereby facilitating the user operating the pliers.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pair of pliers in accordance with the preferred embodiment of the present invention.

FIG. 2 is a top view of the pliers as shown in FIG. 1.

FIG. 3 is a schematic operational view of the pliers as shown in FIG. 2.

FIG. 4 is a schematic operational view of the pliers as shown in FIG. 1.

FIG. 5 is a schematic operational view of the pliers as shown in FIG. 1.

### DETAILED DESCRIPTION OF THE INVENTION

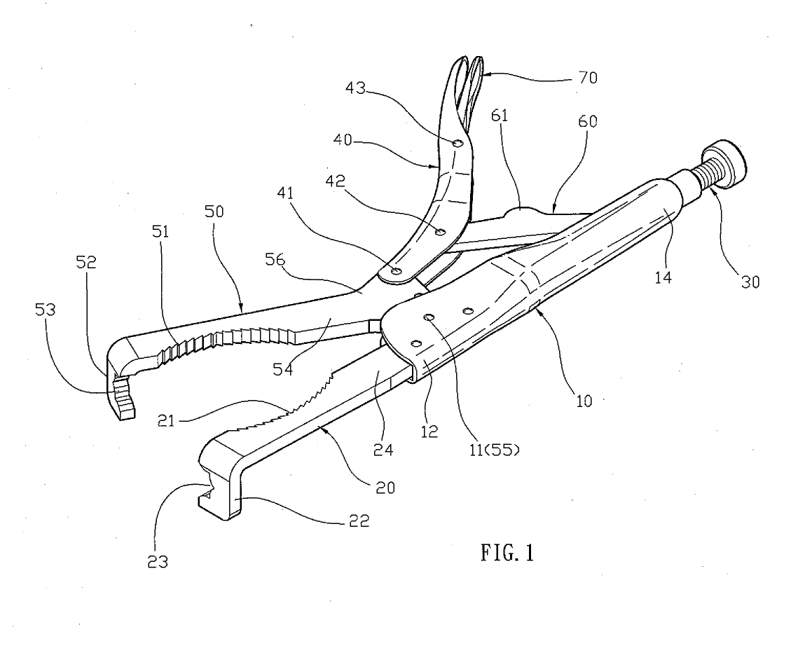

Referring to the drawings and initially to FIGS. 1-3, a pair of pliers in accordance with the preferred embodiment of the present invention comprise a fixed handle 10, a fixed jaw 20 having a first end 24 secured to a first end 12 of the fixed handle 10, a mediate portion provided with a first toothed clamping portion 21 and a second end provided with a first bent portion 22 which is provided with a first holding recess 23, a movable jaw 50 having a first end 54 pivotally mounted on the first end 12 of the fixed handle 10, a mediate portion provided with a second toothed clamping portion 51 facing the first toothed clamping portion 21 of the fixed jaw 20 and a second end provided with a second bent portion 52 which is provided with a second holding recess 53 facing the first holding recess 23 of the fixed jaw 20, a movable handle 40 having a first end pivotally mounted on the first end 54 of the movable jaw 50, a locking lever 60 having a first end pivotally mounted on a mediate portion of the movable handle 40 and a second end adjustably mounted on a second end 14 of the fixed handle 10, an adjusting screw 30 rotatably and movably mounted on the second end 14 of the fixed handle 10 and abutting the second end of the locking lever 60 to push the second end of the locking lever 60, and a release lever 70 pivotally mounted on a second end of the movable handle 40.

The first toothed clamping portion 21 of the fixed jaw 20 is located between the first end 24 of the fixed jaw 20 and the first bent portion 22 of the fixed jaw 20. The first bent portion 22 of the fixed jaw 20 is perpendicular to the fixed jaw 20, and the first holding recess 23 of the fixed jaw 20 is perpendicular to the first toothed clamping portion 21 of the fixed jaw 20.

The second toothed clamping portion 51 of the movable jaw 50 is located between the first end 54 of the movable jaw 50 and the second bent portion 52 of the movable jaw 50. The second bent portion 52 of the movable jaw 50 is perpendicular to the movable jaw 50, and the second holding recess 53 of the movable jaw 50 is perpendicular to the second toothed clamping portion 51 of the movable jaw 50. The first end 54 of the movable jaw 50 has a first side provided with a protruding pivot portion 55 pivotally connected with the first end 12 of the fixed handle 10 by a pivot pin 11 and a second side provided with a protruding pivot section 56 pivotally connected with the first end of the movable handle 40 by a pivot pin 41.

The locking lever 60 has a mediate portion provided with a protruding abutting block 61. The first end of the locking lever 60 is pivotally connected with the mediate portion of the movable handle 40 by a pivot pin 42.

The adjusting screw 30 is rotatable and movable relative to the fixed handle 10 to push the locking lever 60 and the movable handle 40 so as to adjust a distance and tension between the movable jaw 50 and the fixed jaw 20.

The release lever 70 has a mediate portion pivotally mounted on the second end of the movable handle 40 by a pivot pin 43 and has a distal end 72 that is movable to abut the abutting block 61 of the locking lever 60.

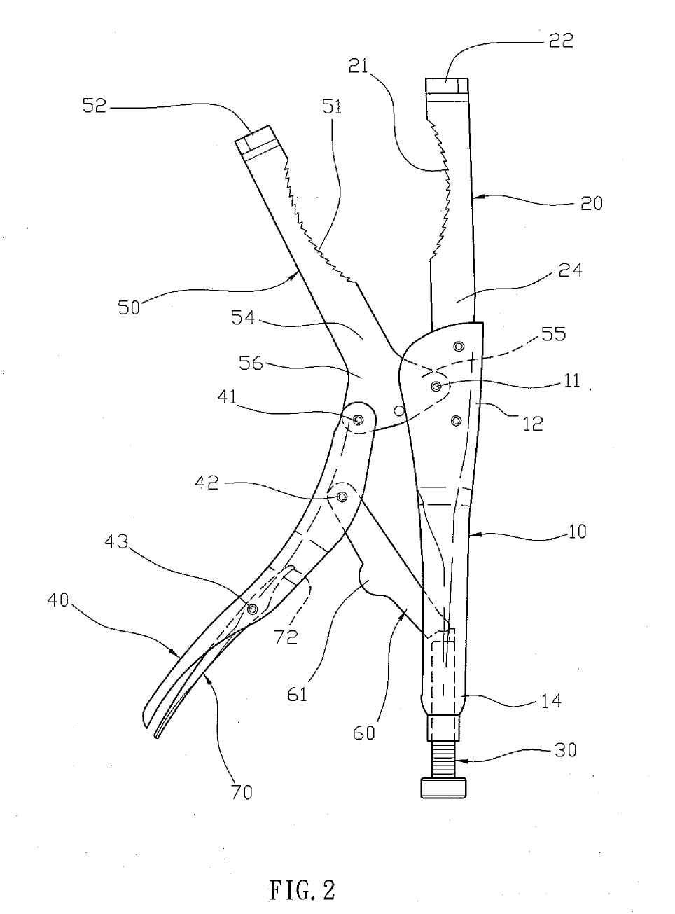

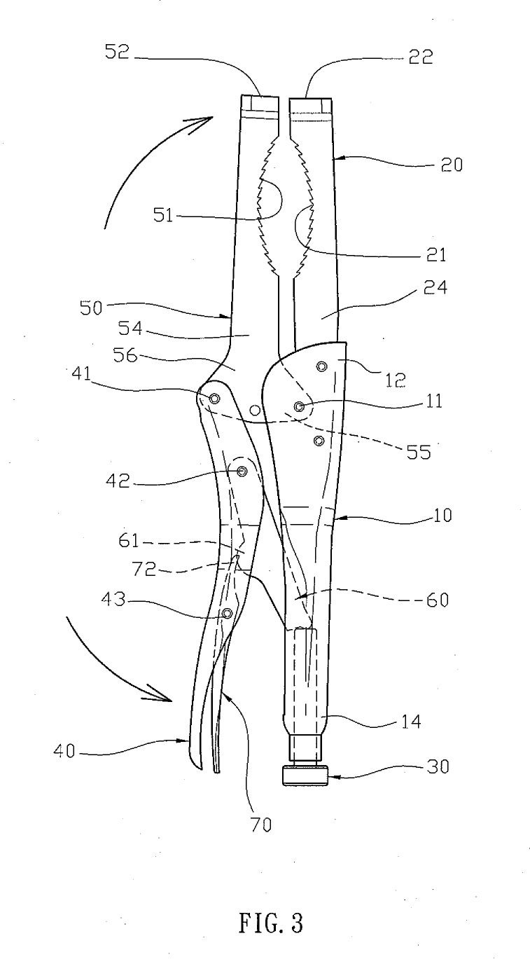

In operation, referring to FIGS. 2 and 3 with reference to FIG. 1, when the movable handle 40 is pressed to move toward the fixed handle 10, the movable jaw 50 is driven by the movable handle 40 to pivot relative to the fixed handle 10 and to move toward the fixed jaw 20 so that the second toothed clamping portion 51 of the movable jaw 50 is movable toward the first toothed clamping portion 21 of the fixed jaw 20, and the second holding recess 53 of the movable jaw 50 is movable toward the first holding recess 23 of the fixed jaw 20.

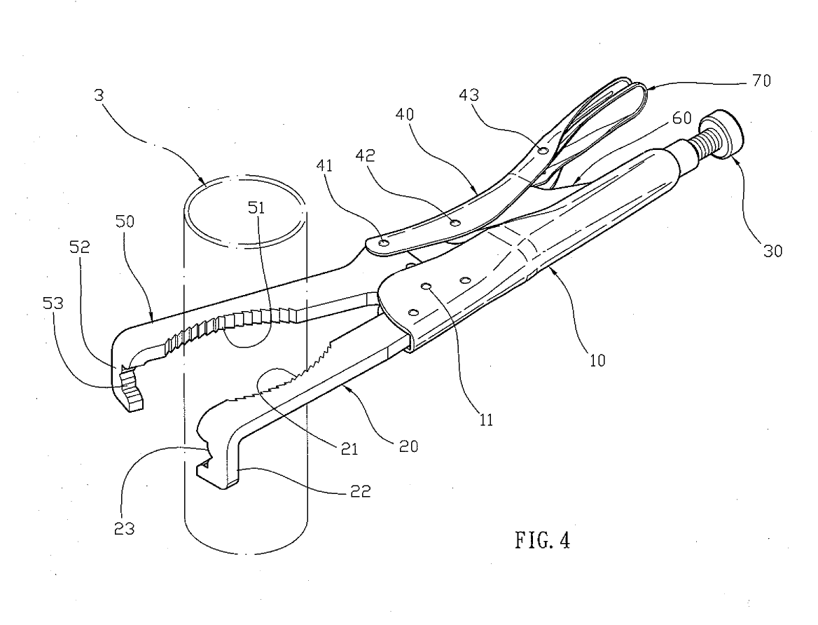

As shown in FIG. 4, the second toothed clamping portion 51 of the movable jaw 50 is movable toward the first toothed clamping portion 21 of the fixed jaw 20 to press and clamp a workpiece, such as a pipe 1, between the second toothed clamping portion 51 of the movable jaw 50 and the first toothed clamping portion 21 of the fixed jaw 20 so that the pipe 1 is operated by the second toothed clamping portion 51 of the movable jaw 50 and the first toothed clamping portion 21 of the fixed jaw 20.

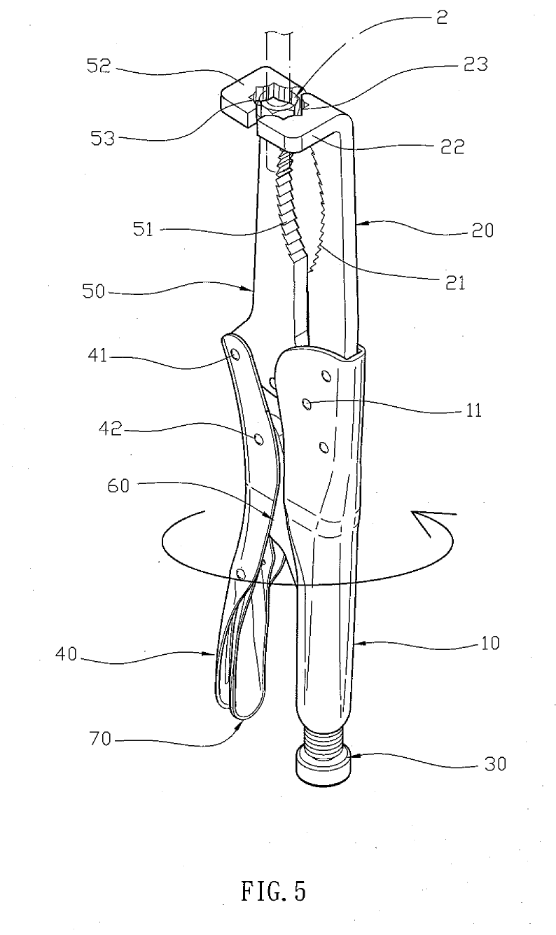

As shown in FIG. 5, the second holding recess 53 of the movable jaw 50 is movable toward the first holding recess 23 of the fixed jaw 20 to press and clamp a workpiece, such as a nut 2 (or screw), between the second holding recess 53 of the movable jaw 50 and the first holding recess 23 of the fixed jaw 20 so that the nut 2 is operated by the second holding recess 53 of the movable jaw 50 and the first holding recess 23 of the fixed jaw 20.

Accordingly, the pliers are used to operate a pipe 1 by the second toothed clamping portion 51 of the movable jaw 50 and the first toothed clamping portion 21 of the fixed jaw 20 and to operate a nut 2 or screw by the second holding recess 53 of the movable jaw 50 and the first holding recess 23 of the fixed jaw 20, so that the pliers can be used to operate workpieces of two different types, thereby enhancing the versatility of the pliers. In addition, a user only needs to prepare the single pliers to operate workpieces of two different types, thereby facilitating the user operating the pliers.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pair of pliers, comprising:
a fixed handle;
a fixed jaw having a first end secured to a first end of the fixed handle, a mediate portion provided with a first toothed clamping portion and a second end provided with a first bent portion which is provided with a first holding recess;
a movable jaw having a first end pivotally mounted on the first end of the fixed handle, a mediate portion provided with a second toothed clamping portion facing the first toothed clamping portion of the fixed jaw and a second end provided with a second bent portion which is provided with a second holding recess facing the first holding recess of the fixed jaw;
a movable handle having a first end pivotally mounted on the first end of the movable jaw; wherein:
the first toothed clamping portion of the fixed jaw and the second toothed clamping portion of the movable jaw co-operate with each other to clamp a circular workpiece;
the first holding recess of the fixed jaw and the second holding recess of the movable jaw co-operate with each other to clamp a polygonal workpiece.

2. The pliers in accordance with claim 1, wherein the first toothed clamping portion of the fixed jaw is located between the first end of the fixed jaw and the first holding recess of the first bent portion of the fixed jaw and is closer to the first holding recess of the first bent portion of the fixed jaw.

3. The pliers in accordance with claim 1, wherein the first bent portion of the fixed jaw is a sheet plate and is perpendicular to the first toothed clamping portion of the fixed jaw.

4. The pliers in accordance with claim 1, wherein the first holding recess of the fixed jaw has a semi-polygonal shape and is perpendicular to the first toothed clamping portion of the fixed jaw.

5. The pliers in accordance with claim 1, wherein the second toothed clamping portion of the movable jaw is located between the first end of the movable jaw and the second holding recess of the second bent portion of the movable jaw and is closer to the second holding recess of the second bent portion of the fixed jaw.

6. The pliers in accordance with claim 1, wherein the second bent portion of the movable jaw is a sheet plate and is perpendicular to the second toothed clamping portion of the movable jaw.

7. The pliers in accordance with claim 4, wherein the second holding recess of the movable jaw has a semi-polygonal shape and is perpendicular to the second toothed clamping portion of the movable jaw.

8. The pliers in accordance with claim 1, wherein the first end of the movable jaw has a first side provided with a protruding pivot portion pivotally connected with the first end of the fixed handle by a first pivot pin and a second side provided with a protruding pivot section pivotally connected with the first end of the movable handle by a second pivot pin.

9. The pliers in accordance with claim 1, further comprising:
a locking lever having a first end pivotally mounted on a mediate portion of the movable handle and a second end adjustably mounted on a second end of the fixed handle;
an adjusting screw rotatably and movably mounted on the second end of the fixed handle and abutting the second end of the locking lever to push the second end of the locking lever;
a release lever pivotally mounted on a second end of the movable handle.

10. The pliers in accordance with claim 9, wherein
the locking lever has a mediate portion provided with a protruding abutting block;
the release lever has a distal end that is movable to abut the abutting block of the locking lever.

11. The pliers in accordance with claim 9, wherein the first end of the locking lever is pivotally connected with the mediate portion of the movable handle by a pivot pin.

12. The pliers in accordance with claim 9, wherein the adjusting screw is rotatable and movable relative to the fixed handle to push the locking lever and the movable handle.

13. The pliers in accordance with claim 9, wherein the release lever has a mediate portion pivotally mounted on the second end of the movable handle by a pivot pin.

14. The pliers in accordance with claim 1, wherein when the movable handle is pressed to move toward the fixed handle, the movable jaw is driven by the movable handle to pivot relative to the fixed handle and to move toward the fixed jaw so that the second toothed clamping portion of the movable jaw is movable toward the first toothed clamping portion of the fixed jaw, and the second holding recess of the movable jaw is movable toward the first holding recess of the fixed jaw simultaneously.

15. The pliers in accordance with claim 1, wherein the first holding recess of the fixed jaw and the second holding recess of the movable jaw co-operate with each other to form a polygonal recess to receive and operate the polygonal workpiece.
